(19) United States
(12) Patent Application Publication
(10) Pub. No.: US 2007/0129189 A1
(43) Pub. Date: Jun. 7, 2007

(54) Belt tension adjustment mechanism

(75) Inventors: Kuo-Ching Huang, Taipei (TW); Yu-Cheng Chang, Taipei (TW)

Correspondence Address: BACON & THOMAS, PLLC, 625 SLATERS LANE, FOURTH FLOOR, ALEXANDRIA, VA, 22314, US

(73) Assignee: Primax Electronics Ltd., Taipei (TW)

(21) Appl. No.: 11/332,340

(22) Filed: Jan. 17, 2006

(30) Foreign Application Priority Data
Dec. 2, 2005 (TW) 094142412

(51) Int. Cl. F16H 7/18; F16H 7/08

(52) U.S. Cl. 474/140; 474/111

(57) ABSTRACT

A belt tension adjustment mechanism for use in an optical module of a scanning apparatus includes a sliding member, a fixture member, a supporting member and a resilient member. The sliding member is arranged on a surface of the optical module and movable on the surface of the optical module. The fixture member is used to fix the belt. The supporting member supports the belt. By means of the resilient member, a tension is applied onto the belt.

### FIELD OF THE INVENTION

The present invention relates to a belt tension adjustment mechanism, and more particularly to a belt tension adjustment mechanism for use in an optical module of a scanning apparatus.

### BACKGROUND OF THE INVENTION

A flatbed image scanner is used to scan a document with the movement of an optical module thereof. The optical module of the flatbed image scanner is moved in the scanning direction by a driving device including a motor, a gear set and a belt. As known, a belt tension adjustment mechanism is necessary to provide sufficient tension to confine the belt, so that the optical module will steadily move in the scanning direction.

For example, a belt tension adjustment mechanism is disclosed in Taiwanese Patent Gazette Publication No. 450,497, which is entitled as “an adjustment mechanism”.

Referring to FIG. 1, a belt tension adjustment mechanism shown in Taiwanese Patent Gazette Publication No. 450,497 includes a spring 1, which is sustained against the belt 2 to provide sufficient tension.

Since the spring 1 is in direct contact with the belt 2, the surface of the belt 2 is readily subject to abrasion and likely to be damaged. In addition, the contact region between the spring 1 and the surface of the belt 2 is not smooth enough, so that the movement of the belt 2 is hindered.

In views of the above-described disadvantages of the prior art, the applicant keeps on carving unflaggingly to develop an improved belt tension adjustment mechanism according to the present invention through wholehearted experience and research.

### SUMMARY OF THE INVENTION

It is an object of the present invention to provide a belt tension adjustment mechanism for offering stable tension to the belt.

In accordance with an aspect of the present invention, there is provided a belt tension adjustment mechanism for use in an optical module of a scanning apparatus. The optical module is movable in a scanning direction. The belt tension adjustment mechanism comprises a sliding member, a fixture member, a supporting member and a resilient member. The sliding member is arranged on a surface of the optical module and movable on the surface of the optical module in a second direction perpendicular to the scanning direction, wherein the sliding member has a curved surface to be in contact with a belt. The fixture member is arranged on a surface of the optical module and adjacent to a first side of the sliding member to fix the belt. The supporting member is arranged on a surface of the optical module and adjacent to a second side of the sliding member to support the belt. The resilient member has an end sustained against the sliding member and the other end sustained against a sidewall.

In an embodiment, the sliding member further comprises a stop piece protruded from the curved surface of the sliding member and a hollow portion.

In an embodiment, the belt tension adjustment mechanism further comprises a protrusion post.

In an embodiment, the resilient member is a compression spring.

Alternatively, the resilient member is a torsion spring with two arms.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view of a belt tension adjustment mechanism according to prior art;

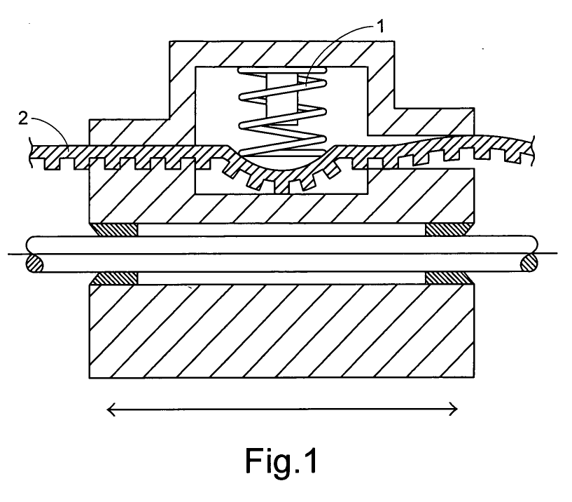

FIG. 2 is a schematic view of a belt tension adjustment mechanism according to a preferred embodiment of the present invention; and

FIG. 3 is a schematic view of a belt tension adjustment mechanism according to another preferred embodiment of the present invention.

### DETAILED DESCRIPTION OF THE PREFERRED EMBODIMENT

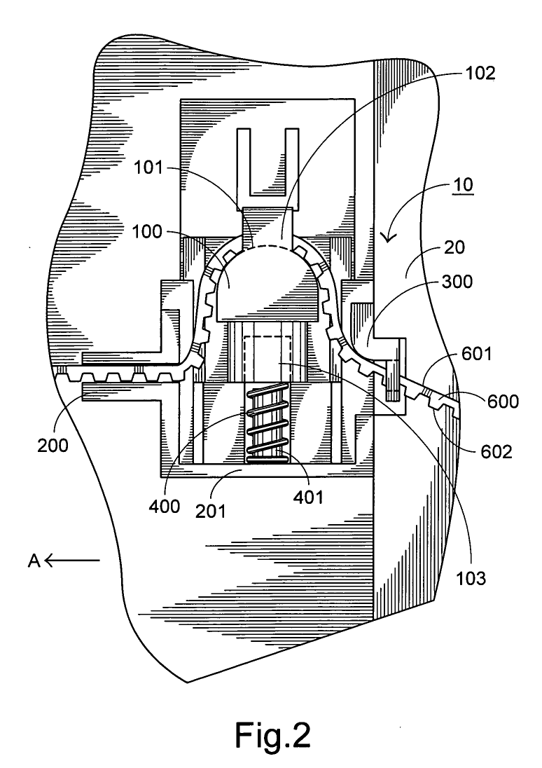

Referring to FIG. 2, a schematic view of a belt tension adjustment mechanism according to a preferred embodiment of the present invention is illustrated.

The belt tension adjustment mechanism 10 is mounted on the optical module 20 of a scanning apparatus. The belt tension adjustment mechanism 10 comprises a sliding member 100, a fixture member 200, a supporting member 300, a resilient member 400 and a protrusion post 401. The sliding member 100 comprises a curved surface 101, a stop piece 102 and a hollow portion 103.

An example of the resilient member 400 is a compression spring sheathed around the protrusion post 401. An end of the resilient member 400 is sustained against a sidewall 201, and the other end of the resilient member 400 is accommodated within the hollow portion 103 of the sliding member 100. In this embodiment, the resilient member 400 is fixed by means of the protrusion post 401 and the hollow portion 103. It is noted that, however, those skilled in the art will readily observe that the resilient member 400 may be fixed by other means. Accordingly, the above disclosure should be limited only by the bounds of the following claims.

The belt 600 is made cyclic and encloses around two rollers (not shown) arranged at the left and right sides of the belt 600. The curved surface 101 of the sliding member 100 is sustained against a portion of the belt 600. In addition, the belt 600 is clamped by the fixture member 200 at one side of the sliding member 100 and supported by the supporting member 300 at the opposite side of the sliding member 100. When the optical module is moved along the scanning direction A to perform the scanning operation, the sliding member 100 will be moved in the direction perpendicular to the scanning direction A. The belt 600 comprises a smooth surface 601 and a teeth structure 602 opposed to the smooth surface 601. The teeth structure 602 is in contact with the sliding member 100. The smooth surface 601 is in contact with the supporting member 300. Alternatively, the teeth structure 602 is separated from the sliding member 100. Whereas, once the belt tension adjustment mechanism 10 is rotated by 180 degrees, the smooth surface 601 is in contact with sliding member 100. In addition, the belt 600 is stopped by the stop piece 102 so as to prevent detachment of the belt 600 from the curved surface 101 of the sliding member 100.

When the belt 600 is mounted on the belt tension adjustment mechanism 10, the belt 600 is pushed against the sliding member 100. Meanwhile, in response to the elastic force generated from the spring 400, the belt 600 is suppressed by means of the sliding member 100, thereby providing stable tension to the belt.

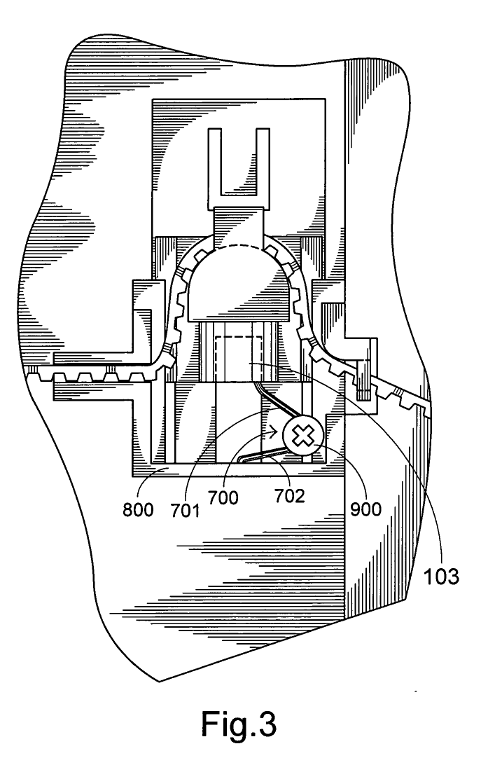

A further embodiment of a belt tension adjustment mechanism is illustrated in FIG. 3. In this embodiment, the sliding member, the fixture member and the supporting member included therein are similar to those shown in FIG. 2, and are not to be redundantly described herein. The main difference between the belt tension adjustment mechanism of FIG. 3 and that of FIG. 2 is the resilient member. The resilient member of FIG. 3 is a torsion spring 700. The torsion spring 700 includes a spiral part (not shown) and two arms 701 and 702. The spiral part is sheathed around the protrusion post 900. The arm structure 701 is sustained against the hollow portion 103 of the sliding member 100. The arm structure 702 is sustained against the sidewall 800. Likewise, in response to the elastic force generated from the torsion spring 700, the belt 600 is suppressed by means of the sliding member 100, thereby providing sufficient tension to confine the belt.

From the above description, the belt tension adjustment mechanism of the present invention is capable of providing stable tension to the belt by using the sliding member movable along the surface of the scanning module. In addition, since the resilient member is not in direct contact with the belt, abrasion of the belt will not readily occur.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A belt tension adjustment mechanism for use in an optical module of a scanning apparatus, said optical module being movable in a scanning direction, said belt tension adjustment mechanism comprising:
a sliding member arranged on a surface of said optical module and movable on said surface of said optical module in a second direction perpendicular to said scanning direction, wherein said sliding member has a curved surface to be in contact with a belt;
a fixture member arranged on a surface of said optical module and adjacent to a first side of said sliding member to fix said belt;
a supporting member arranged on a surface of said optical module and adjacent to a second side of said sliding member to support said belt; and
a resilient member having an end sustained against said sliding member and the other end sustained against a sidewall.

2. The belt tension adjustment mechanism according to claim 1 wherein said sliding member further comprises:
a stop piece protruded from said curved surface of said sliding member; and
a hollow portion.

3. The belt tension adjustment mechanism according to claim 2 further comprising a protrusion post.

4. The belt tension adjustment mechanism according to claim 3 wherein said resilient member is a compression spring.

5. The belt tension adjustment mechanism according to claim 3 wherein said resilient member is a torsion spring with two arms.
